(19) United States
(12) Patent Application Publication
(10) Pub. No.: US 2007/0044950 A1
(43) Pub. Date: Mar. 1, 2007

(54) Device for exchanging heat

(75) Inventors: Prasanta Halder, Ditzingen-Heimerdingen (DE); Evripidis Koukouravas, Neckartenzlingen (DE)

Correspondence Address: FOLEY AND LARDNER LLP;SUITE 500, 3000 K STREET NW, WASHINGTON, DC, 20007, US

(73) Assignee: BEHR GmbH & CO. KG, Stuttgart (DE)

(21) Appl. No.: 10/552,279

(22) PCT Filed: Mar. 22, 2004
(86) PCT No.: PCT/EP04/02969

§ 371 Date: Oct. 30, 2006

(30) Foreign Application Priority Data
Apr. 4, 2003 (DE) 103 15 733.6

(51) Int. Cl. B60H 3/00; B60H 1/00

(52) U.S. Cl. 165/202; 165/42

(57) ABSTRACT

Disclosed is a device (1) used for exchanging and delivering heat, especially for a motor vehicle comprising an apparatus for delivering an especially gaseous medium, a heating apparatus (5) for heating at least one portion of the gaseous medium, at least one space (7) that is disposed downstream of the heating apparatus relative to the direction of flow of the gaseous medium, at least two ducts (12a, 12h, 12c, 12d) for the gaseous medium, which originate within said space and extend into at least two air conditioning zones of the interior of the motor vehicle. A control mechanism which regulates the quantity of the medium flowing through the duct is provided inside at least one of the ducts while the heating apparatus is provided with at least two, preferably a plurality of, throughput devices for a second medium, at least two of said throughput devices being designed in a different manner.

The invention relates to a device for exchanging heat, especially for motor vehicles.

Devices for exchanging heat, such as, for example, air conditioning systems for motor vehicles, have been known for a long time from the prior art. In these systems, there is a need for individual part regions of the vehicle interior, for example the front region and the back region, to be air-conditioned separately. For this purpose, in the prior art, the devices for exchanging heat have a plurality of separate heating bodies, for example, for the front and back regions of a motor vehicle. This leads, however, to a greater construction space requirement.

The object on which the invention is based is, therefore, to make available a device for exchanging and transmitting heat, which, on the one hand, allows the separate air conditioning of various regions of a vehicle interior and, on the other hand, as compared with conventional devices for exchanging heat, manages with a construction space which is not or not appreciably enlarged.

This is achieved, according to the invention, by means of a device for exchanging and supplying heat, especially for a motor vehicle, which has a supply means for supplying an especially gaseous medium, a heating means for heating at least part of the gaseous medium, at least one space arranged downstream of the heating means in the flow direction of the gaseous medium, and at least two ducts for the gaseous medium which emanate from the space and which lead into at least two air conditioning zones of the interior of the motor vehicle. In this case, in at least one of the ducts, a regulating means is provided which regulates the quantity of the medium flowing through the duct. The heating means has at least two, preferably a multiplicity of throughflow means for a second medium, at least two of these throughflow means being configured differently.

What is meant in this context by a supply means is a means which is suitable for conducting especially gaseous medium in a predetermined direction, such as, for example, a flow duct or the like. What is meant by the gaseous medium is especially air, but also other gases. However, only air is referred to below.

A space is distinguished, within the scope of the present invention, in that it is surrounded by walls or other essentially gas-impermeable boundaries, but may have orifices in individual preferential directions.

What is meant by a duct is a positive guide for the air which conducts the air to a predetermined location, for example the front region of a motor vehicle.

Within the scope of the present invention, the second medium is an especially liquid medium which, where a heat exchanger is concerned, can discharge heat into the air. In a preferred embodiment, the supply means for the air is a space arranged upstream of the heating means in the flow direction of the air. Preferably, a further device for exchanging heat, such as, in particular, an evaporator, is arranged in the supply means. Preferably, also, a fan, ventilator or the like is provided, which at least partially accelerates the movement of the air in the flow direction. Furthermore, additional heating elements, such as, in particular, but not exclusively, PTC (Positive Temperature Coefficient) heating elements, may be provided upstream or downstream of the heating means in the flow direction.

Preferably, as illustrated, the heating means has at least one second, especially liquid medium flowing through it and has a plurality of supply lines and/or discharge lines for the second medium. The second medium is preferably water from the cooling circuit of the internal combustion engine of the motor vehicle, but other media may also be envisaged. Preferably, in this case, the heating means has three supplies and two discharges for the second medium. Preferably, this at least one supply and/or discharge of the heating means has a regulating or control means, in order to regulate and/or control the quantity of the liquid medium flowing through the supply and consequently passing into the corresponding circuit of the heat means. What may be considered as regulating means are, for example, regulating valves.

In a further embodiment, the heating means is subdivided into a plurality of regions, the heat exchange with the air being regulated on the water side in at least one of these regions and on the air side in at least one of these regions.

What is meant by water-side regulation is that the temperature of the air penetrating through the heating means is regulated essentially by means of a variation in the parameters of the water flowing through the heating means, that is to say, in particular, by means of the temperature and quantity of the water. For this purpose, there may be mounted, for example at the inflow, a regulating valve which regulates or controls the quantity of the water flowing through the heating means.

What is meant by air-side regulation is that the quantity and/or temperature of the liquid medium flowing through the heating means, that is to say of the water, is kept essentially constant, and additional regulating means control or regulate what quantity of air flows through the heating means and what quantity of air flows past the latter, in order thereby to set a variable mixture ratio downstream of the heating means in the flow direction and thus regulate or control the desired mixing temperature of the air.

In a further preferred embodiment, the throughflow means have a cross section in the manner of a flat tube.

What is meant in this context by the manner of a flat tube is that the throughflow means have a cross section which has at least one longer and one shorter side, the longer side being substantially longer than the shorter side. It would therefore be possible, for example, to have a rectangular cross section, a longer side being substantially longer than the shorter side, or an elliptic cross section, the longer diameter exceeding by far the shorter diameter. The throughflow means in the manner of a flat tube may have inside them one or more flow ducts.

In a further preferred embodiment, at least one of the throughflow means has at least one curved portion. What is meant in this context by a curved portion is that the flow of a medium in a throughflow means especially in the manner of a flat tube changes its direction through a predetermined angle and this change is brought about by positive guidance by the throughflow means, the throughflow means itself not needing to be curved.

Preferably, also, at least one of the throughflow means has essentially no portion curved in the longitudinal direction, that is to say extends from one end portion of the throughflow means to a second end portion of the throughflow means rectilinearly. Preferably, the device for exchanging heat has a multiplicity of throughflow means with at least one curved portion and a multiplicity of throughflow means without a curved portion.

In a further preferred embodiment, a heating means is provided which has at least one collecting and/or distributing means, on which at least one supply line or at least one discharge line is provided. Preferably, the devices have two collecting and/or distributing means, on which all the supply and discharge lines are provided. It is also possible, however, to provide a plurality of collecting and/or distributing means.

In a further preferred embodiment, in at least one of the collecting and/or distributing means, first separating means are provided, which subdivide the collecting and/or distributing means into at least two subspaces in a liquid-tight manner. The separating means may be, for example, partitions which are pushed from outside into the collecting and/or distributing means and are subsequently welded or adhesively bonded to the latter or fixed to the latter in a similar way.

Preferably, in this case, both distributing and/or collecting spaces have separating means of this type.

In a further preferred embodiment, in this case, at least one collecting and/or distributing means, preferably both collecting and/or distributing means, have a second separating means, the surface normal of this second separating means being essentially perpendicular to the surface normal of the first separating means. Instead of the second separating means, however, two separate collecting and/or distributing spaces may also be provided, which are arranged parallel and opposite to one another at at least one end of the throughflow means.

In a further preferred embodiment, three liquid streams run at least partially separately from one another within the heating means. Preferably, however, a common discharge and/or supply may also be provided for two or more liquid streams. For this purpose, three supplies and two discharges for the liquid medium are provided on the heating means.

In a further embodiment, at least one of the throughflow means is bent or curved through an angle of essentially 180°. What is meant in this context by a curvature of the throughflow means through 180° is that the flow direction of the liquid medium is essentially reversed within the throughflow means. In this case, preferably, the throughflow means is curved essentially in the region of the geometric center, that is to say the flow direction is reversed approximately in the region of the center of the throughflow means, so that an initial portion and an end portion of the throughflow means lie at essentially the same height. The throughflow means preferably project into the distributing and/or collecting means in such a way that there is a fluid connection between the throughflow means and the collecting and/or distributing means. In a further preferred embodiment, at least two of the curved throughflow means are connected in one part to one another. In this case, the respective end portions of one throughflow means point in the opposite direction to the end portions of the other throughflow means.

In a further preferred embodiment, two or more spaces separated from one another are provided downstream of the heating means. In this case, a plurality of ducts for the air emanate from the plurality of spaces and lead into a plurality of air conditioning zones of the interior of the motor vehicle. Said ducts may be, for example, ducts for the left, that is to say driver's side, front region of the vehicle, the right, that is to say front-seat passenger's side, front region of the vehicle, a rear region and a foot region at the front and/or at the rear, and further regions, such as the front windshield, rear window etc. In a further embodiment, in one, preferably in a plurality, and, especially preferably, in each of the ducts, a regulating means is provided which regulates the quantity of the medium flowing through the duct. This regulating means may be, for example, a ventilation flap which can be set variably, so that the quantity of the medium, that is to say of the air, flowing through the duct or through an end portion of the duct is controlled and/or regulated. This regulating means may, for example, be capable of being set manually; motor control could, however, also be envisaged.

In a further preferred embodiment, at least one regulating means is provided, which is not arranged in one of the ducts for the gaseous medium. Preferably, this at least one regulating means may be arranged upstream of the heating means, directly downstream of the heating means or next to the heating means in the flow direction of the air.

In a further preferred embodiment, at least one regulating means is arranged upstream of a predetermined region of the heating means in the flow direction of the air.

Further advantages and embodiments may be gathered from the accompanying drawings in which:

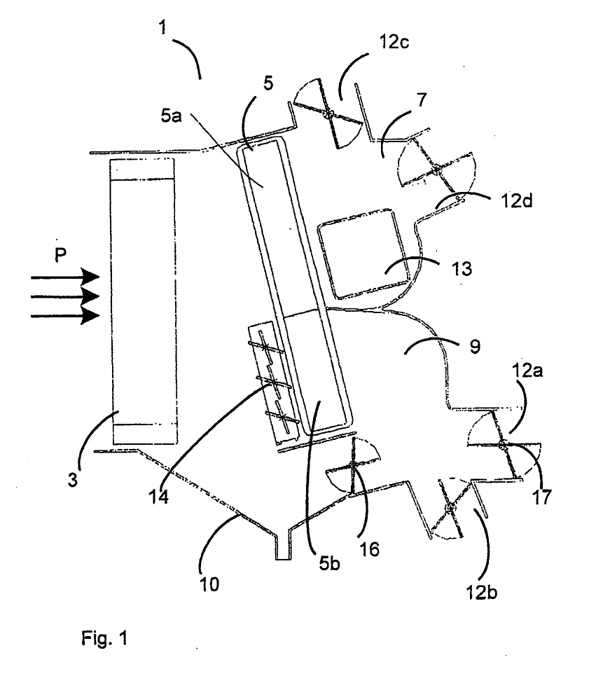

FIG. 1 shows a diagrammatic illustration of a device according to the invention for exchanging and supplying heat;

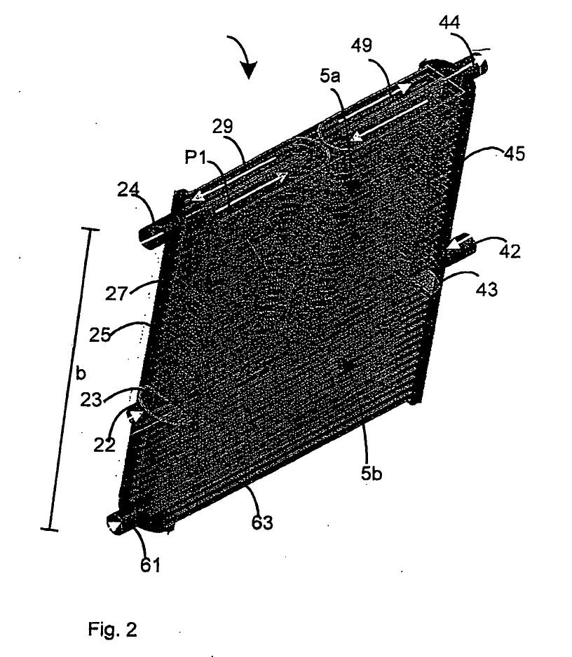

FIG. 2 shows an illustration of a heating means for a device according to the invention for exchanging heat;

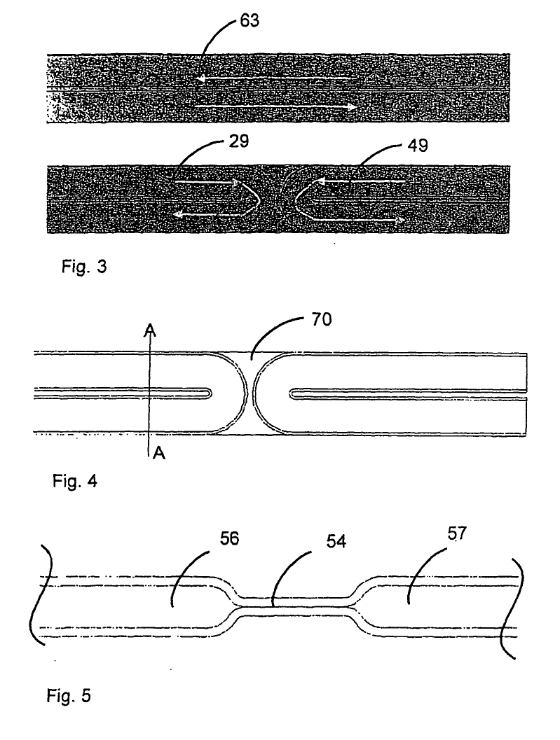

FIG. 3 shows an illustration of the throughflow means for the heating means from FIG. 2;

FIG. 4 shows a further illustration of the throughflow means for the heating means from FIG. 2; and

FIG. 5 shows a top view of the throughflow means along the line A-A in FIG. 4.

FIG. 1 illustrates a device according to the invention for exchanging heat, especially for a motor vehicle. In this context, reference symbol 2 relates to the supply means, that is to say, in this case, a supply duct for the air. The flow direction of the air is indicated by the three arrows P. A fan or the like (not shown) may be arranged upstream of the duct. Reference symbol 3 denotes a means for exchanging heat, such as, for example, an evaporator. Reference symbol 5 within the device housing 10 relates to a heating means which is subdivided into two regions 5a and 5b.

Upstream of the region 5b of the heating means 5 are arranged three regulating means 14 which can regulate and change or control the quantity of the air stream flowing through the region 5b of the heating means 5. More or fewer such regulating means 14 may, however, also be provided at this point.

A further regulating means 16 is provided below the heating means 5 in the drawing. The quantity of air which flows past the heating means can be regulated by this regulating means. In particular, the mixture ratio of the air passing into the space 9 can also be regulated by this regulating means in cooperation with the regulating means 14. Consequently, by definition, air-side regulation takes place here. The parameters of the medium flowing through the region 5b of the heating means, such as pressure and temperature, are kept essentially constant, and the temperature of the air passing into the space 9 is regulated essentially via the fractions of the air which are conducted through the region 5b of the heating means and the fractions which are conducted past below the region 5b.

Two ducts 12a and 12b extend from the space 9 lying downstream of the heating means in the flow direction. In these ducts 12a and 12b, two further regulating means 17 for regulating or controlling the air passing through these ducts are provided. These regulating means 17 may be, for example, air flaps. The two ducts 12a and 12b may lead, for example, to a rear region of the vehicle interior.

Reference symbol 7 denotes a further space which is arranged downstream of the region 5a of the heating means 5 in the flow direction. This space 7, too, has two ducts 12c and 12d which may lead, for example, into a front region of a motor vehicle interior. In addition, a duct 13 may also be provided, which may lead, for example, into the foot space of the driver and/or front-seat passenger. No additional regulating means are provided in the flow direction from the region 5a of the heating means. The heating of the air during its passage through the region 5a of the heating means 5 is regulated essentially by means of the quantity and/or the temperature of the medium flowing through this region, so that water-side regulation may be referred to here.

FIG. 2 shows a heating means 5 for the device according to the invention for exchanging heat. Reference symbols 5a and 5b show the regions of the heating means 5.

Reference symbols 22 and 42 relate to supplies for a liquid into the heating means. This liquid is preferably water from the cooling circuit of the motor vehicle engine. Reference symbols 24 and 44 relate to discharges for said liquid. The liquid passes via the supplies 22 and 42 into a distributing and/or collecting means 27.

The liquid is distributed to a multiplicity of flat tubes 29 by the distributing and/or collecting means 27.

As illustrated by the arrow P1, the liquid flows from here to the right in the figure, that is to say toward the throughflow means 49. Within the throughflow means 29, the liquid reverses its flow direction through 180° and flows back into the collecting and distributing means 25 and out of the heating means there via the discharge line 24. Instead of two separate distributing and/or collecting means 25 and 27, one distributing and/or collecting means can also be provided, although this would then have to be subdivided into two subspaces by a separating means running in the direction b.

The liquid runs through the throughflow means 49 in a similar way. The liquid passes via the supply 42 into the collecting and/or distributing means 45 and from there into the throughflow means 49. As indicated by the arrows, there, too, the liquid runs first to the left in the figure, that is to say toward the throughflow means 29.

Here, too, the liquid is reversed in its flow direction through 180° in the throughflow means 49 and finally passes into the collecting and distributing means 47 (not shown) and from there out of the device via the discharge line 44.

The partitions 23 and 43 prevent the situation where the liquid may be propagated along the entire direction b of the heating means. The region 5b of the device therefore has a separate supply 61 and discharge (not shown) for the liquid medium. However, as explained in more detail below, the partition 23 subdivides the distributing and/or collecting means 27 only, but not the collecting and/or distributing means 25, into two part regions.

The refrigerant is conducted via the supply 61 into the distributing and/or collecting means 27, that is to say into that region of the collecting and distributing space which belongs to the region 5b. It passes from there via the throughflow means 63 in the direction of the collecting and/or distributing means 45, once again in the region 5b of the heating means. The refrigerant passes from there into the distributing and/or collecting means 47 (not shown), which is arranged parallel downstream of the collecting and/or distributing means 45, and from there via the throughflow means 63 into the distributing and/or collecting and/or distributing means 25. Although, as stated, the separating means 23 separates the distributing and/or collecting means 27 into two subspaces, it does not separate the collecting and/or distributing means 25. Consequently, the liquid can likewise pass into the discharge line 24 and be discharged by this out of the heating means. The discharge line 24 therefore serves for discharging the liquids both out of the region 5b and out of that part of the region 5a which is on the left in the figure. The heating means consequently has three different flow regions for the liquid.

FIG. 3 shows details of the throughflow means 29, 49 and 63. The arrows in each case illustrate the flow direction of the liquid within the throughflow means. The throughflow means may have one or more ducts for the liquid.

FIG. 4 shows a further illustration of the throughflow means 29 and 49. The two throughflow means are preferably produced as a whole in one part.

FIG. 5 shows a top view of the two throughflow means 29 and 49 along the line A-A from FIG. 4. In this case, the respective edge regions on the left and right have been omitted. In order to have the effect that the liquid can flow in two directions within the throughflow means, the middle portion 54 of the throughflow means is compressed, thus giving rise to two sections 56 and 57 in which the liquid flows in each case in a different direction, that is to say, here, into the sheet plane in one case and out of the sheet plane in the other case.

What can be achieved in the region 70 between the throughflow means 29 and the throughflow means 49 by suitable material machining is that the flow direction of the liquid flowing into the throughflow means 29 and 49 is reversed. This may be achieved, for example, in that the throughflow means is compressed in the region 70 shown in FIG. 4 and two arcuate reversal regions are thereby obtained. It is also possible, however, to bend the throughflow means through 180° approximately in its center, in order thereby to achieve a reversal of the flow direction in this region.

1. A device for exchanging and supplying heat, especially for a motor vehicle, with:
a supply means for supplying an especially gaseous medium;
a heating means for heating at least part of the gaseous medium;
at least one space arranged downstream of the heating means in the flow direction of the gaseous medium;
at least two ducts for the gaseous medium which emanate from the space and which lead into at least two air conditioning zones of the interior of the motor vehicle; wherein
in at least one of the ducts, a regulating means is provided, which regulates the quantity of the medium flowing through the duct; and
the heating means has at least two, preferably a multiplicity of throughflow means for a second medium, at least two of these throughflow means being configured differently.

2. The device as claimed in claim 1, wherein
the supply means for the especially gaseous medium is a space arranged upstream of the heating means in the flow direction of the gaseous medium.

3. The device as claimed in claim 1, wherein
a further device for exchanging heat, especially an evaporator, is arranged in the supply means.

4. The device as claimed in claim 1, wherein
a fan is provided, which at least partially accelerates the movement of the gaseous medium in the flow direction.

5. The device especially as claimed in claim 1, wherein
the heating means has at least one second medium flowing through it and has a plurality of supply lines and/or discharge lines for the second medium.

6. The device as claimed in claim 1, wherein
the heating means has three supplies and two discharges for the second medium.

7. The device as claimed in claim 1, wherein
at least one supply and/or discharge of the heating means for the second medium has a regulating and/or control means which regulates and/or controls the quantity of the medium flowing through this supply and/or discharge.

8. The device as claimed in claim 1, wherein
the throughflow means have a cross section in the manner of a flat tube.

9. The device as claimed in claim 1, wherein
at least one of the throughflow means has at least one curved portion.

10. The device as claimed in claim 1, wherein
at least one of the throughflow means has essentially no portion curved in the longitudinal direction.

11. The device as claimed in claim 1, wherein
the heating means has at least one collecting and/or distributing means, on which at least one supply line and/or at least one discharge line is provided.

12. The device as claimed in claim 1, wherein
the device has two or more collecting and/or distributing means, on which all the supply and/or discharge lines are provided.

13. The device as claimed in claim 12, wherein
in at least one of the collecting and/or distributing means, first separating means are provided, which subdivide the collecting and/or distributing spaces into at least two subspaces in a liquid-tight manner.

14. The device as claimed in claim 1, wherein
at least one collecting and/or distributing means has at least one second separating means, the surface normal of this second separating means being essentially perpendicular to the surface normal of the first separating means.

15. The device as claimed in claim 12, wherein
at least one of the collecting and/or distributing means has no separating means.

16. The device as claimed in claim 1, wherein
three liquid streams run essentially separately from one another within the heating means.

17. The device as claimed in claim 1, wherein
at least one of the throughflow means is bent or curved through an angle of essentially 180°.

18. The device as claimed in claim 1, wherein
at least one of the throughflow means has a region of smaller thickness, essentially no fluid stream taking place through this region of smaller thickness.

19. The device as claimed in claim 1, wherein
at least two of the curved throughflow means are connected to one another in one part.

20. The device as claimed in claim 1, wherein
a plurality of ducts for the gaseous medium emanate from the at least one space arranged downstream of the heating means and lead into a plurality of air conditioning zones of the interior of the motor vehicle.

21. The device as claimed in claim 1, wherein
in at least one, preferably in each of the ducts, a regulating means is provided, which regulates the quantity of the medium flowing through the duct.

22. The device as claimed in claim 1, wherein
at least one regulating device is provided, which is not arranged in one of the ducts for the gaseous medium.

23. The device as claimed in claim 1, wherein
in the supply, at least one regulating means is provided, which regulates the quantity of the medium flowing at least through a part region of the supply means.

24. The device as claimed in claim 1, wherein
at least one regulating means is set up upstream of a predetermined region of the heating means in the flow direction of the gaseous medium.

25. The device as claimed in claim 1, wherein
at least two spaces separated from one another are provided downstream of the heating means in the flow direction of the gaseous medium.

26. The device as claimed in claim 1, wherein
a plurality of ducts emanate from each of the spaces arranged downstream of the heating means in the flow direction of the gaseous medium and lead into a plurality of air conditioning zones in the interior of the motor vehicle.
